(19) United States
(12) Patent Application Publication
(10) Pub. No.: US 2005/0183376 A1
(43) Pub. Date: Aug. 25, 2005

(54) Space truss structure surface slab assembly

(76) Inventor: Bunichi Shoji, Mito (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/066,301

(22) Filed: Feb. 28, 2005

(30) Foreign Application Priority Data
Sep. 1, 2003 (JP) 2003-308336

(51) Int. Cl. G02B 5/124; E04B 1/18; E04C 3/02; E04B 5/10; E04B 5/18

(52) U.S. Cl. 52/633

(57) ABSTRACT

An apex rhombus is delimited over the center point of a square, which is delimited by plotting four nadir rhombuses on the same plane, and each of the nadir rhombuses and the apex rhombus are jointed to form a group of pyramidal surfaces equipped with four planar slopes having substantially the same height in a pyramidal form. Two pyramidal surface slabs are assembled, each composed of pyramidal surfaces around one pyramidal surface, each sharing one nadir rhombus, adjacent each other, and arranged in a grid pattern at an equal pitch in plural directions. The pyramidal surfaces arranged in a grid pattern are each displaced by one-half pitch in a specific direction, such that the apex rhombus of one of the pyramidal surface comes in contact with the nadir rhombus of the other pyramidal surface, whereby the two pyramidal surfaces are placed one on the other.

### FIELD OF THE INVENTION

The present invention relates to a space truss structure surface slab assembly.

### BACKGROUND OF THE INVENTION

The Japanese Application Patent Laid-open Publication No. 10-181593 discloses the structure of a rolling stock car body. This structure is made of a plurality of aluminum alloy hollow extruded members having a closed cross section, and it comprises an outer plate, an inner plate, and a partition for holding these plates at a predetermined spaced interval and jointing them to form a triangle.

The Japanese Application Patent Laid-open Publications No. 3340533 describes a truss panel type core material, wherein sheet materials consisting of a wooden single plate or plywood sheet are combined to form a truss, as seen when its cross section is viewed from one side. This truss panel type core material is composed of a top layer panel made of a sheet material, a bottom layer panel made of a sheet material, and a saw blade-like intermediate web bonded by an adhesive to each of the aforementioned top and bottom layer panels. The aforementioned intermediate web is composed of a plurality of strip-shaped sheet materials and bonding tapes, and the front and back of the edge of the sheet material are cut off in an oblique form relative to each other, wherein the tip ends of the obliquely cut-off tapered portions are butted with each other, and a bonding tape is attached on the back of each tapered portion.

The Japanese Application Patent Laid-open Publications No. 10-166481 discloses a panel core material provided between two spaced panels arranged in parallel, wherein the aforementioned core material is made of paper having a predetermined thickness, and a cone-shaped portion of a plurality of approximately quadrangular pyramidal members, each projecting in opposite directions, is formed by a plurality of hexagonal inclined surfaces, with two inclined surfaces on both sides having a rectangular edge jointed with each other, and a head crest is jointed to the sides of both ends of this inclined surface.

### SUMMARY OF THE INVENTION

To make it possible to obtain getting a large-area plate or assembly through use of hollow core materials according to prior techniques, a hollow core material has been fabricated using grid-like ribs or honeycomb boards, and this member is covered with a surface slab, whereby a finished product is obtained. These prior techniques, however, have the following inherent problems:

1) A processed plate in any type of material has a low dynamic efficiency for strength, and is characterized by a low productivity.

2) The surface slab thickness is increased if the hollow core material has a coarse grid pitch, and the thickness of the hollow grid member is decreased if the hollow core material has a fine grid pitch. Thus, the economic efficiency is very low for the required strength.

3) A urethane resin or honeycomb paper is used as the hollow material, but the scope of application is limited due to poor strength, and inflammability is a problem in the case of urethane.

4) At present, there is no processed plate based on the use of hollow core material, fabricated by prior known techniques, which alone is applicable as the structure of a vehicle, ship, aircraft or building.

To solve these problems, the object of the present invention is to provide space truss structure surface slab assemblies having different high strengths.

The configuration of the space truss structure surface slab assembly in accordance with the present invention is as follows:

An apex rhombus is delimited over the center point of a polygon delimited by plotting a plurality of nadir rhombuses on one and the same plane. Each of the aforementioned nadir rhombuses and the apex rhombus are jointed to form a group of pyramidal surfaces equipped with a plurality of planar slopes and having substantially the same height in a triangular pyramid. Two pyramidal surface slabs are assembled, each of which is composed of pyramidal surfaces around one pyramidal surface, each sharing one of said nadir rhombuses, adjacent to each other, and arranged in a grid pattern at an equal pitch in two or three directions. The pyramidal surfaces arranged in a grid pattern are each displaced by one-half the pitch in a specific direction, in such a way that the apex rhombus of one of the pyramidal surfaces is opposed to the nadir rhombus of the other pyramidal surface, and the apex rhombus of the other pyramidal surface is opposed to the nadir rhombus of the counterpart, whereby said two pyramidal surfaces are assembled. Furthermore, the apex rhombus of one pyramidal surface slab and the nadir rhombus of the other pyramidal surface slab opposed thereto are integrally jointed by bonding or welding, whereby a space truss structure surface slab assembly is formed.

An apex rhombus is delimited over the center point of a polygon—for example, triangle or square—, which is delimited by plotting a plurality of—for example, three or four—nadir rhombuses on one and the same plane. Each of the aforementioned nadir rhombuses and the aforementioned apex rhombus are jointed to form a group of pyramidal surfaces equipped with a plurality of—for example, three or four—planar slopes and having substantially the same height in a pyramidal form. Two pyramidal surface slabs are assembled, each of which is composed of the pyramidal surfaces around one pyramidal surface each sharing one of said nadir rhombuses, adjacent to each other, and they are arranged in a grid pattern at an equal pitch in two or three directions. The pyramidal surfaces arranged in a grid pattern are each displaced by half the pitch in the aforementioned specific direction, in such a way that the apex rhombus of one of the pyramidal surfaces is opposed to the nadir rhombus of the other pyramidal surface in contact therewith, and the apex rhombus of the other pyramidal surface is opposed to the nadir rhombus of the counterpart, whereby said two pyramidal surfaces are placed one on top of the other and are assembled. The apex rhombus of one pyramidal surface slab and the nadir rhombus of the other pyramidal surface slab opposed thereto in contact are integrally jointed by bonding or welding, whereby a space truss structure assembly is formed.

A planar surface plate is laminated outside each of the two pyramidal surface slabs so that the space truss structure assembly is sandwiched between them.

An apex rhombus is delimited over the center point of a polygon delimited by plotting four nadir rhombuses on one and the same plane. Each of the aforementioned nadir rhombuses and the apex rhombus are jointed to form a group of pyramidal surfaces equipped with four planar slopes and having substantially the same height in a triangular pyramid. Two pyramidal surface slabs are assembled, each of which is composed of the pyramidal surfaces around one pyramidal surface, each sharing one of said nadir rhombuses, adjacent to each other, and arranged in a grid pattern at an equal pitch in two or three directions. The pyramidal surfaces arranged in a grid pattern are each displaced by one-half pitch in a specific direction, in such a way that the apex rhombus of one of the pyramidal surfaces is opposed to the nadir rhombus of the other pyramidal surface, and the apex rhombus of the other pyramidal surface is opposed to the nadir rhombus of the counterpart, whereby said two pyramidal surfaces are assembled. Furthermore, the apex rhombus of one pyramidal surface slab and the nadir rhombus of the other pyramidal surface slab opposed thereto are integrally jointed by bonding or welding, whereby a space truss structure surface slab assembly is formed.

Thus, the present invention ensures economical production of a panel core material applicable to a large or massive structure obtained by volume production, and provides a truss structure surface slab assembly of high strength by reducing the pyramidal surface pitch. For example, it can be used to construct the hull partition and bulkhead of a ship, a floor, wall and roof body of a vehicle, and the floor, wall and roof of a building, without using a column or beam. It allows construction of a massive glass surface slab assembly, without using a metallic frame. The present invention provides these structures at extremely low costs.

### BRIEF DESCRIPTION OF THE DRAWINGS

FIG. 1 is a diagram representing how to configure a space truss structure surface slab assembly;

FIG. 2 is a diagram representing details of the partial view of FIG. 1;

FIG. 3 is a diagram showing a two-piece set of pyramidal surface slabs prior to assembly;

FIG. 4 is a diagram showing the assembly as a first embodiment;

FIG. 5 is a diagram representing an alternative to the arrangement of FIG. 3;

FIG. 6 is a diagram representing an alternative to the structure of FIG. 4;

FIG. 7 is a diagram representing details of another pyramidal surface;

FIG. 8 is a diagram showing a two-piece set of pyramidal surface slabs prior to assembly;

FIG. 9 is a diagram showing a pyramidal surface slab representing a second embodiment;

FIG. 10 is a diagram representing how to configure a space truss structure surface slab assembly according to a third embodiment;

FIG. 11 is a diagram representing details of the partial view of FIG. 8;

FIG. 12 is a diagram showing a two-piece set of pyramidal surface slabs prior to assembly;

FIG. 13 is a diagram showing the assembly according to the third embodiment;

FIG. 14 is a diagrammatic cross sectional view of a pyramidal surface slab already formed;

FIG. 15 is a diagrammatic cross sectional view of a space truss structure surface slab assembly;

FIG. 16 is a diagram showing an alternative arrangement to that of FIG. 12;

FIG. 17 is a diagram showing an alternative arrangement to that of FIG. 13;

FIG. 18 is a diagram showing an alternative arrangement to that of FIG. 14;

FIG. 19 is a diagram showing an alternative arrangement to that of FIG. 15;

FIG. 20 is a diagram representing the dynamic properties of a space truss structure surface slab assembly;

FIG. 21 is a stress mechanism diagram;

FIG. 22(a) is a diagram showing a prior example, and FIG. 22(b) is a diagram which shows an example of the use of corrugated cardboard;

FIG. 23 is a diagram showing an example of using the present invention as the truck deck plate of a truck, and the roof and wall body of a container car;

FIG. 24(a) is a diagram showing an example of application of the present invention to an aircraft body and floor, and FIG. 24(b) is a diagram which shows an example of application of the present invention to a propeller;

FIG. 25(a) is a diagrammatic side view representing an prior example, FIG. 25(b) a diagrammatic cross sectional view showing the prior art example, and FIG. 25(c) is a diagram showing a deck and bulkhead of a ship such as a tanker;

FIG. 26 is a diagram showing a floor slab and wall slab of a building, such as a house;

FIG. 27 is a diagram showing an example of application of the present invention to a glass wall slab and roof slab having a great height;

FIGS. 28(a) and 28(b) are diagrams showing an example of application of the present invention to a large-sized circular tank of a pressure vessel, wherein FIG. 28(a) is a plane view, and FIG. 28(b) is a cross sectional view; and

FIG. 29(a) is a diagram showing a prior example of a ship structure, and FIG. 29(b) is a diagram which shows a space truss structure surface slab hull structure in accordance with the present invention.

### EMBODIMENTS OF THE PRESENT INVENTION

### Embodiment 1

A description of preferred embodiments will be provided with reference to the drawings:

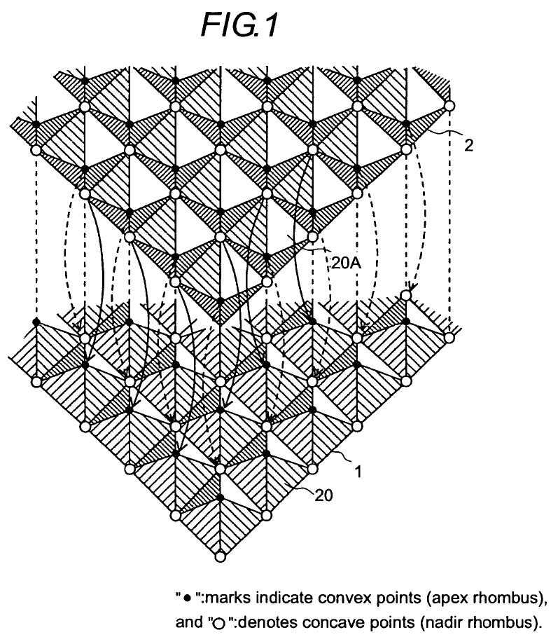

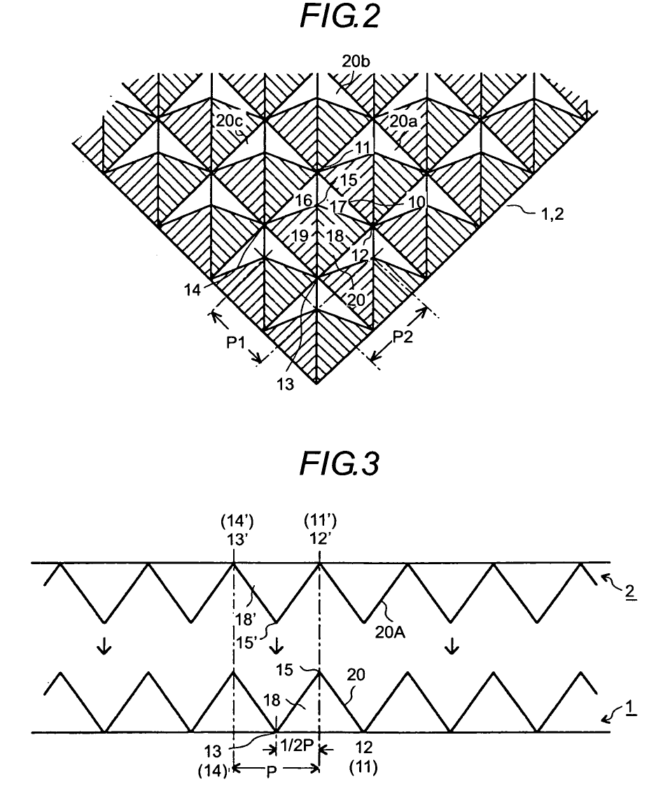

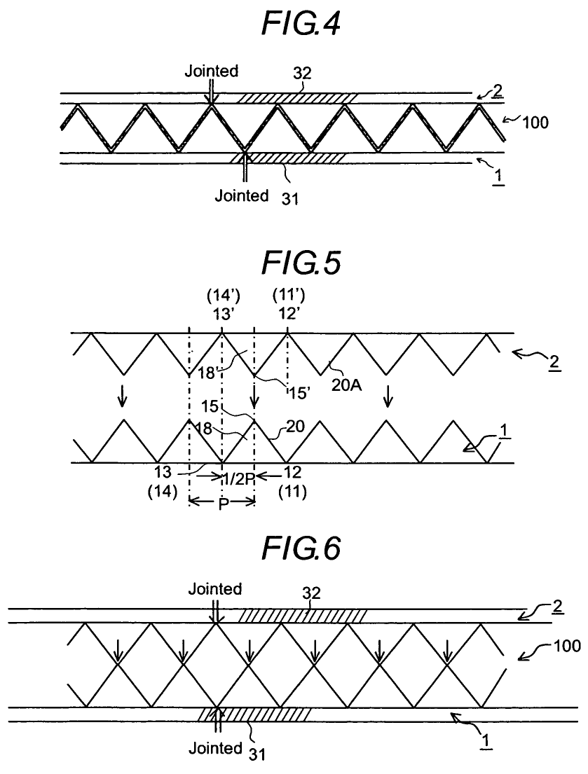

FIGS. 1 through 4 show a first embodiment of the present invention. FIG. 1 shows how to configure a space truss structure surface slab assembly. FIG. 2 provides details of a partial view in FIG. 1. FIG. 3 shows a two-piece set of pyramidal surface slabs prior to assembling. FIG. 4 shows the assembly thereof as a first embodiment.

In FIG. 1, two pyramidal surfaces 1 and 2 are used to configure the space truss structure surface slab assembly.

Referring first to FIG. 2, the configuration of the pyramidal surface slabs 1 and 2 will be described. Pyramidal surface slabs 1 and 2 are fabricated from one of sheet material, for example, a metal sheet formed through injection processing by a stamping die. As will be described later, except for the metal sheet, a non-metallic material such as corrugated cardboard, lumber, plywood, plastics and glass can be used as a sheet material.

As shown in FIG. 2, in the pyramidal surface slabs 1 and 2, an apex rhombus 15 is delimited over the center point of a square 10 by plotting four nadir rhombuses 11, 12, 13 and 14. Accordingly, the apex rhombus 15 is formed on a half pitch line. Each of the nadir rhombuses 11, 12, 13 and 14 and apex rhombus 15 are jointed to form a group of pyramidal surfaces represented as an assembly of the pyramidal surface 20 having substantially the same height as four planar quadrangular pyramids. Here the term “nadir rhombus” is defined to include the edge line of the nadir and its surrounding, and the term “apex rhombus” is defined to include the edge line of the apex and its surrounding. The term “rhombic portion” refers to the entire edge line. Using the pyramidal surface group as this pyramid, the pyramidal surfaces 20a, 20b and 20c around one pyramidal surface 20 share one of the nadir rhombuses, for example, the nadir rhombus 11 as a common nadir rhombus, together with the pyramidal surface 20c. To put it another way, the common point is a point that is used in common. A set of pyramidal surface slabs 1 and 2 are shaped in a form arranged in a grid pattern adjacent to each other. Further, pyramidal surfaces are arranged regularly in the longitudinal and lateral directions at the same pitches P_{1 and P}₂. One pyramidal surface is surrounded by eight adjacent pyramidal surfaces (four are in line contact, while the other four are in point contact). In this case, it is surrounded by one in the lateral direction on the paper surface, one in the vertical direction and one each in the oblique diagonal line direction. One pyramidal surface 20 has a square nadir and is surrounded as described above. A nadir rhombus is formed in each square portion at a position as a neighboring point of the four adjacent pyramidal surfaces. This nadir rhombus is also a final point reached by the external lines of the slopes 16, 17, 18 and 19 extending toward the aforementioned square from the apex rhombus. Here the term “rhombus” is used because four edge lines extend in four directions from one point as the nadir, as shown in the drawing, and a rhombic form is visually perceived.

The apex rhombus is formed like a spearhead providing a sharp-edged angle. If this portion is made flat, the space truss to be described later cannot be formed. As will be described later, this sharp-edged portion is used for welding or bonding. The height of the pyramidal surface can be set in accordance with the purpose of use.

A row of pyramidal surfaces formed on a set of pyramidal surface slabs 1 and 2 by processing and molding are arranged at an equal pitch in a grid pattern in a specific direction—in this case, two directions, namely, lateral and vertical directions (or two directions of oblique line)—in the present embodiment. Thus, the rows of the apex rhombuses and nadir rhombuses are also arranged at an equal pitch in a grid pattern in the lateral direction and vertical direction.

Two sets of pyramidal surface slabs 1 and 2 formed in this manner are arranged opposite to each other, as shown in FIG. 1, and the rows of pyramidal surfaces are displaced a half pitch and they are jointed. Thus, the apex rhombus of each pyramidal surface comes in contact with the nadir rhombus of the other pyramidal surface, and the apex rhombus of the other pyramidal surface is brought into contact with the nadir rhombus of the counterpart so as to be overlapped one on top of the other.

In the manner described above, they are arranged in an opposed form and are moved in the arrow marked direction so that they are placed one on top of the other. Referring to FIG. 1, the aforementioned procedure of overlapping will be described.

In FIG. 1, two sets of pyramidal surface slabs 1 and 2 are used to configure an assembly. The lower pyramidal surface slab 1 faces upward and the pyramidal surface 20 is protruded upwardly (convex). The upper pyramidal surface slab 2 faces downward and the pyramidal surface 20A (having the same configuration as the pyramidal surface 20, represented with “A” suffixed thereto) is protruded downwardly (concave). In this arrangement, the apex rhombus of one of the pyramidal surfaces comes in contact with the nadir rhombus of the other pyramidal surface in the form opposite thereto, and the nadir rhombus comes in contact with the apex rhombus in the form opposite thereto. Viewed from the other pyramidal surface, the apex of the other pyramidal surface comes in contact with the nadir rhombus of the counterpart pyramidal surface, and the nadir rhombus comes in contact with the apex rhombus opposite thereto. Overlapping is effected in the aforementioned manner.

In the case of overlapping them, two sets of pyramidal surface slabs 1 and 2, each equipped with pyramidal surfaces 20 and 20A, appear to be engaged with each other. In this way, two sets of pyramidal surface slabs 1 and 2 are overlapped. The apex rhombus and nadir rhombus as engaged concave and convex points are assumed as forming a one-point contact point, and all overlapped apex rhombuses and nadir rhombuses are used as intersections, whereby jointing is carried out by bonding or welding.

Whether bonding or welding is used can be determined in conformity with the material of the pyramidal surface slabs 1 and 2. The edge line of two overlapped rhombuses is jointed by intermittent bonding or continuous welding, as required.

FIG. 3 shows that the pyramidal surface slabs as continuously molded plates of planar quadrangular pyramids having the same shape are overlapped and jointed, with two rhombic portions placed opposite to each other, so that a space truss structure surface slab assembly will be formed. The two sets of pyramidal surface slabs 1 and 2 serve as panel core materials. As described above, the pyramidal surface slabs 1 and 2 are each displaced by a half pitch (P₁ and P₂) and are placed opposite to each other. This arrangement allows the apex rhombus 15 of the pyramidal surface slab 1 to be placed opposite to the nadir rhombus 12′ of the other pyramidal surface slab 2. The apex rhombus 15′ of the other pyramidal surface slab 2 is placed opposite to the nadir rhombus 13 of the counterpart pyramidal surface slab 1. The slope 18 is placed opposite to the space formed between the counterpart pyramidal surfaces. This is applicable as well to the case of the slope 18′. The slopes 18 and 18′ are formed by a sheet. Thus, their back is formed as a grooved space. In the present embodiment, P₁=P₂.

In FIG. 3, one set consists of two pyramidal surface slabs, which are overlapped in mutually opposite positions. Each apex and the nadir overlapped relative thereto are jointed by bonding or welding. The rhombic portions as edge lines of the overlapped seam are jointed continuously or intermittently by bonding or welding, as required. However, jointing of the rhombus is not mandatory.

When a set of two pyramidal surface slabs are used for jointing, a grid pattern jointed to the pyramidal surface slabs of the upper and lower chords can be obtained. This linear grid plays an important role for the space truss structure surface slab assembly.

As shown in FIG. 4, finish layers 31 and 32 (surface slab or reinforcing flat plate) can each be laminated on the pyramidal surface slabs 1 and 2 of the upper and lower chords. To put it another way, the space truss structure surface slab assembly 100 formed as a core member is sandwiched between the finish layers 31 and 32.

FIGS. 5 and 6 illustrate an alternative to the examples shown in FIGS. 3 and 4. In the examples shown in FIGS. 3 and 4, the apex rhombus of one pyramidal surface and the nadir rhombus of the other pyramidal surface disposed opposite thereto are integrally jointed by bonding or welding, whereby a space truss structure surface slab assembly is formed. In the example of the variation shown in FIG. 5, the apex rhombus of one pyramidal surface slab and the apex rhombus of the other pyramidal surface slab located opposite thereto are integrally jointed by welding, whereby a space truss structure surface slab assembly is formed, as seen in FIG. 6.

### Embodiment 2

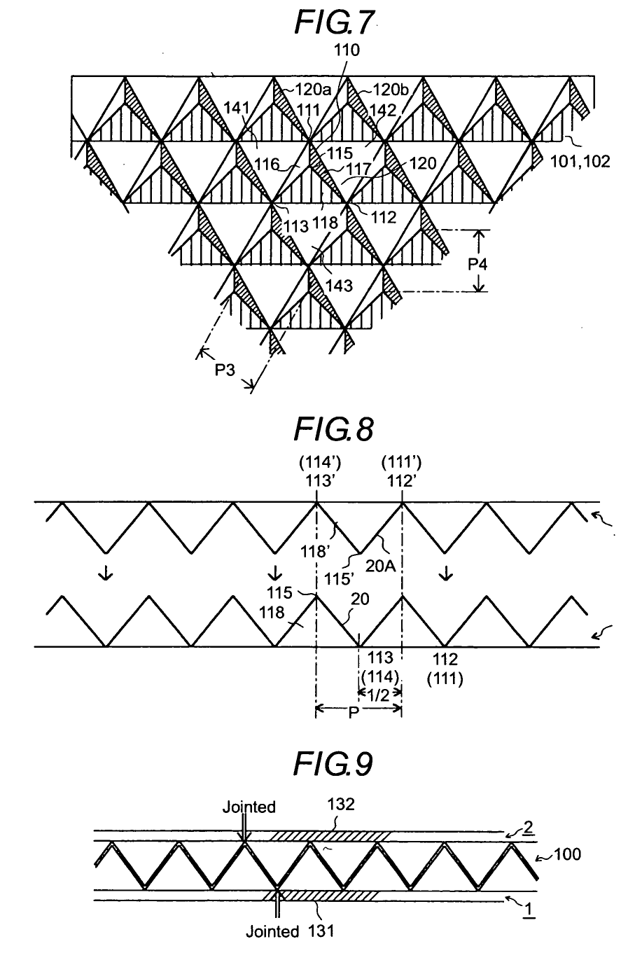

FIGS. 7 through 9 show a second embodiment of the present invention. FIG. 7 shows the details of the pyramidal surface; while, FIGS. 8 and 9 show how to assemble a two-piece set of the pyramidal surface slabs used in the present embodiment.

To configure a space truss structure surface slab assembly, two pyramidal surface slabs 101 and 102 are used in a manner similar to that shown in FIG. 1. Referring to FIG. 7, the configuration of the pyramidal surface slabs 101 and 102 will be described. The pyramidal surface slabs 101 and 102 are produced from one plate-like material, for example, a metallic plate, by a molding operation using a stamping die.

As shown in FIG. 7, the pyramidal surface slabs 101 and 102 are delimited by plotting three nadir rhombuses 111, 112 and 113. An apex rhombus 115 is delimited above the center point of a triangle 110, and each of the nadir rhombuses 111, 112 and 113 and the apex rhombus 115 are plotted to form a group of pyramidal surfaces provided as an assembly of the pyramidal surface 120 equipped with three planar slopes 116, 117 and 118 and having substantially the same height in a triangular pyramid. Using this pyramidal surface group, the pyramidal surfaces 120a and 120b around one pyramidal surface 120 share one of the nadir rhombuses—for example, the nadir rhombus 111—as a common nadir rhombus, with the pyramidal surface 120.

In the manner as stated above, one set of pyramidal surface slabs 101 and 102 is arranged at an equal pitch in a grid pattern. Further, the pyramidal surfaces are regularly arranged in two oblique directions and a lateral direction (direction can be changed by turning the paper surface) at the same pitch widths P₃ and P₄. One pyramidal surface is surrounded by six adjacent pyramidal surfaces in a manner somewhat different from that in the first embodiment. One pyramidal surface is surrounded by two adjacent pyramidal surfaces upwardly, two adjacent pyramidal surfaces laterally, and two adjacent pyramidal surfaces downwardly through the planar triangles 141, 142 and 143 formed around it. One pyramidal surface has a triangular bottom and is surrounded in the above-stated manner. The nadir rhombus is formed at a triangular corner as an adjacent point of the three adjacent pyramidal surfaces. This nadir rhombus is also a final point reached by the external lines of the planar slopes 116, 117 and 118 extending from the apex rhombus toward the aforementioned triangle.

The apex rhombus is formed in a spearhead shape providing a sharp corner. The rows of the pyramidal surfaces, which are formed on the pyramidal surface slabs 101 and 102 by molding, are arranged at an equal pitch in a grid pattern in a specific direction—in this case, three directions, namely, two oblique directions and one lateral direction—in the present embodiment. Thus, the rows of the apex rhombuses and nadir rhombuses are also arranged at an equal pitch in a grid pattern in two oblique directions and one lateral direction. The pyramidal surface slabs 101 and 102 formed in this manner are arranged opposite to each other, and the rows of the pyramidal surfaces are displaced by a half pitch and they are jointed. Thus, the apex rhombus of each pyramidal surface comes in contact with a nadir rhombus of the other pyramidal surface, and the apex rhombus of the other pyramidal surface is brought into contact with a nadir rhombus of the counterpart, so that they are overlapped one on top of the other.

FIG. 7 shows that the pyramidal surface slabs, provided as continuously molded plates of thin-sheet planar triangular pyramids having the same shape, are overlapped and jointed, with two rhombic portions placed opposite to each other, so that a space truss structure surface slab assembly will be formed. The two sets of pyramidal surface slabs 101 and 102 serve as panel core materials.

As described above, the pyramidal surface slabs 101 and 102 are each displaced by a half pitch (P₃ and P₄) and are placed opposite to each other. This arrangement allows the apex rhombus 115 of the pyramidal surface slab 101 to be placed opposite to the nadir rhombus 112′ of the other pyramidal surface slab 112. The apex rhombus 115′ of the other pyramidal surface slab 102 is placed opposite to the nadir rhombus 113′ of the counterpart pyramidal surface slab 100. In this manner, they are arranged in mutually opposite sides and are placed one on top of the other, in the same manner as demonstrated in FIG. 1.

In FIG. 8, one set consists of two pyramidal surface slabs, which are overlapped in mutually opposite positions. Each apex and the nadir overlapped thereto are jointed by bonding or welding. The rhombic portions as edge lines of the overlapped seam are jointed either continuously or intermittently by either bonding or welding, as required. However, jointing of the rhombus is not mandatory.

When a set of two pyramidal surface slabs are used for jointing, a grid pattern jointed to the pyramidal surface slabs of the upper and lower chords can be obtained. This linear grid plays an important role for the space truss structure surface slab assembly.

As shown in FIG. 9, the finish layers 131 and 132 can each be disposed so as to sandwich the pyramidal surface slabs 101 and 102 of the upper and lower chords therebetween.

In the two preceding embodiments, a pyramidal surface slab provided as a square or triangular pyramidal surface has been described. It is also possible to use a polygonal form, such as a pentagonal or other form.

The illustrated examples also may be formed to include the variation shown in FIG. 6.

### Embodiment 3

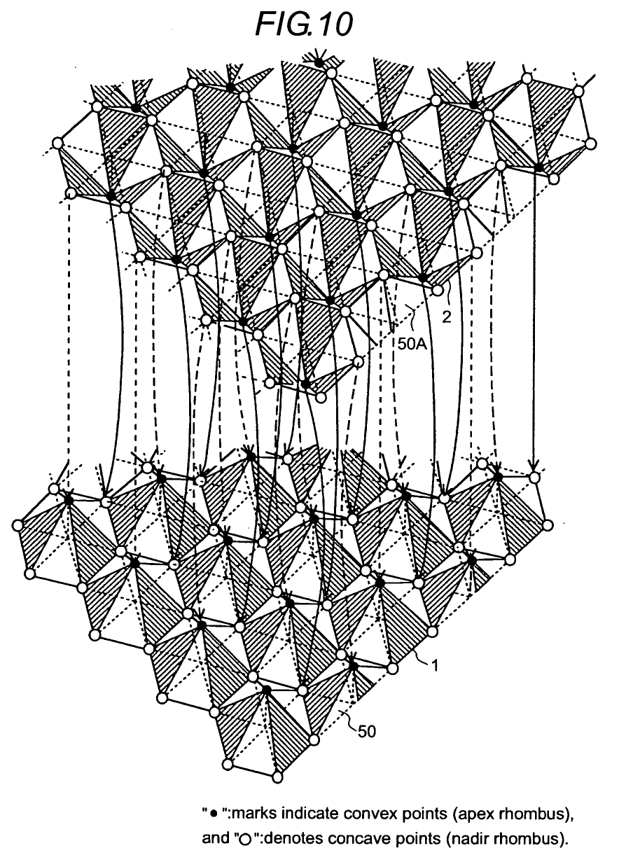

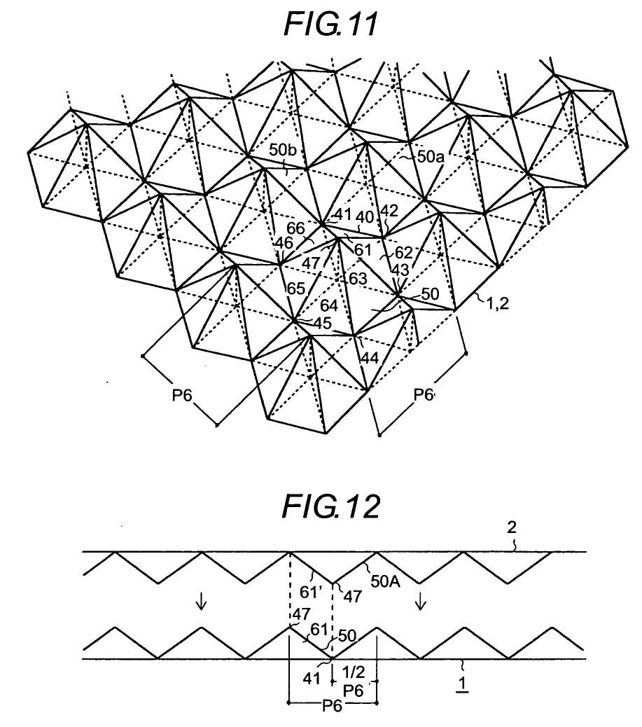

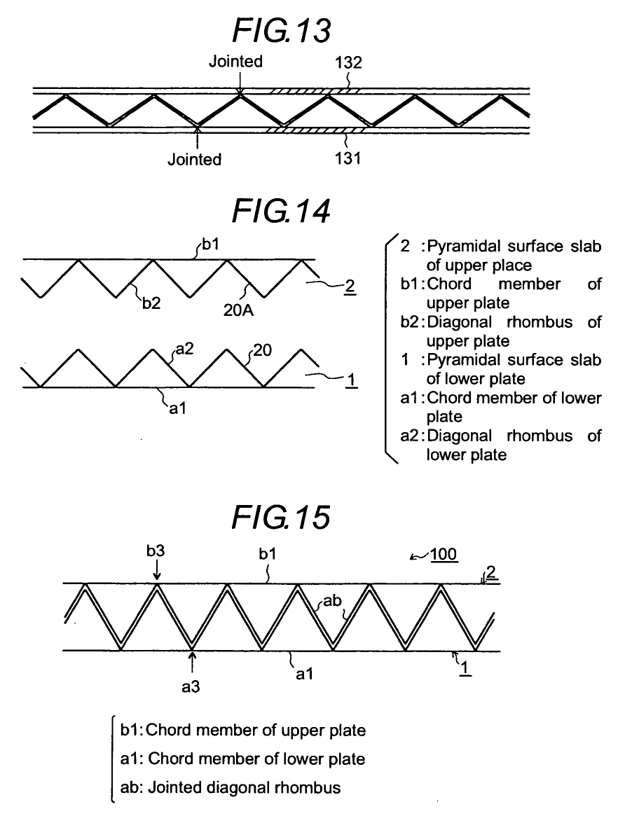

FIG. 10 shows an example of a third embodiment in which a pyramidal surface slab containing a hexagonal pyramidal surface is employed. FIGS. 10 through 13 show the details of the third embodiment. FIG. 10 shows how to configure a space truss structure surface slab assembly, and FIG. 11 shows details thereof in a partial view of FIG. 10. FIG. 12 and FIG. 13 show how to assemble a two-piece set of pyramidal surface slabs used in the present embodiment.

In FIG. 10, two sets of pyramidal surface slabs 1 and 2 are used to configure a space truss structure surface slab assembly.

Referring to FIG. 11, the configuration of the pyramidal surface slabs 1 and 2 will be described. The pyramidal surface slabs 1 and 2 are produced from one plate-formed material—for example, sheet metal—by a molding operation using a stamping die. As shown in FIG. 11, an apex rhombus 47 is delimited over the center point of a hexagon 40 that is delimited by plotting six nadir rhombuses 41, 42, 43, 44, 45 and 46. Accordingly, the apex rhombus 47 is formed on a half pitch line.

Each of the nadir rhombuses 41, 42, 43, 44, 45 and 46 and the apex rhombus 47 are jointed to form a group of pyramidal surfaces as an assembly of the pyramidal surface 50 having substantially the same height as four planar hexagonal pyramids. Using this pyramidal surface group, the pyramidal surfaces 50a, 50b and 50c around one pyramidal surface 50 share one of the nadir rhombuses—for example, the nadir rhombus 41—as a common nadir rhombus, with the pyramidal surface 50. The common point is a point used in common.

In the manner as stated above, one set of pyramidal surface slabs 1 and 2 is formed so as to be arranged at an equal pitch in a grid pattern. Further, the pyramidal surfaces are regularly arranged in the longitudinal and lateral directions at the same pitch width P₆ in parallel. One pyramidal surface is surrounded by six adjacent pyramidal surfaces. One pyramidal surface 50 has a hexagonal bottom and is surrounded in the above-stated manner. The nadir rhombus is formed at the hexagonal corner as the adjacent point of six adjacent pyramidal surfaces. This nadir rhombus is also a final point reached by the external lines of the slopes 61, 62, 63, 64, 65 and 66 extending from the apex rhombus toward the aforementioned hexagon.

The apex rhombus is formed in a spearhead shape providing a sharp corner. If this portion is made flat, the space truss to be described later cannot be formed. As will be described later, this sharp-edged portion is used for welding or bonding. The height of the pyramidal surface can be set in accordance with the purpose of use.

A row of the pyramidal surfaces formed on the pyramidal surface slabs 1 and 2 by molding are arranged at an equal pitch in a grid pattern in a specific direction—in this case, two directions, namely, lateral and vertical (or two directions of oblique lines) directions—in the present embodiment. Thus, the rows of the apex rhombuses and nadir rhombuses are also arranged at an equal pitch in a grid pattern in the lateral direction and vertical direction.

Two sets of pyramidal surface slabs 1 and 2 formed in this manner are arranged opposite to each other, as shown in FIG. 10, and the rows of the pyramidal surfaces are displaced by a half pitch and they are jointed. Thus, the apex rhombus of each pyramidal surface comes in contact with a nadir rhombus of the other pyramidal surface, and the apex rhombus of the other pyramidal surface is brought into contact with a nadir rhombus of the counterpart so that they are overlapped one on top of the other.

In the manner described above, they are arranged in an opposed form and are moved in the arrow marked direction so that they are placed one on top of the other. Referring to FIG. 10, the aforementioned procedure of overlapping will be described.

In FIG. 10, two sets of pyramidal surface slabs 1 and 2 are used to configure an assembly. The lower pyramidal surface slab 1 faces upward and the pyramidal surface 50 is protruded upwardly (convex). The upper pyramidal surface slab 2 faces downward and the pyramidal surface 50A (having the same configuration as the pyramidal surface 50, represented with “A” suffixed thereto) is protruded downwardly (concave). In this arrangement, the apex rhombus of one of the pyramidal surfaces comes in contact with the nadir rhombus of another pyramidal surface in the form opposite thereto, and the nadir rhombus comes in contact with an apex rhombus in the form opposite thereto. Viewed from the other pyramidal surface, the apex of the other pyramidal surface comes in contact with the nadir rhombus of the counterpart pyramidal surface, and the nadir rhombus comes in contact with the apex rhombus opposite thereto. Overlapping is effected in this manner.

In the case of overlapping between them, two sets of pyramidal surface slabs 1 and 2, each equipped with pyramidal surfaces 50 and 50A, appear to be engaged with each other. In this way, two sets of pyramidal surface slabs 1 and 2 are overlapped. The apex rhombus and nadir rhombus provided as engaged concave and convex points, are assumed to form a one-point contact point, and all overlapped apex rhombuses and nadir rhombuses are used as intersections, whereby jointing is effected by bonding or welding.

Whether bonding or welding is used can be determined in conformity to the material of the pyramidal surface slabs 1 and 2. The edge line of two overlapped rhombuses is jointed by intermittent bonding or continuous welding, as required.

FIG. 12 shows that the thin-sheet pyramidal surface slabs provided as continuously molded slabs of planar hexagonal pyramids having the same shape are overlapped and jointed, with two rhombic portions placed opposite to each other, so that the space truss structure surface slab assembly will be formed. Two sets of pyramidal surface slabs 1 and 2 serve as panel core materials. As described above, the pyramidal surface slabs 1 and 2 are each displaced by a half pitch P₆ and are disposed opposite to each other. This arrangement allows the apex rhombus 47 of the pyramidal surface slab 1 to be located opposite to the nadir rhombus 47′ of the other pyramidal surface slab 2. The apex rhombus 47 of the other pyramidal surface slab 2 is disposed opposite to the nadir rhombus 41 of the counterpart pyramidal surface slab 1. This is applicable to the case of the slope 61. The slopes 61 and 61′ are formed by a sheet. Thus, their back is formed as a grooved space.

In FIG. 12, one set consists of two pyramidal surface slabs, which are overlapped in mutually opposite positions. Each apex and the nadir overlapped thereto are jointed by bonding or welding. The rhombic portions provided as edge lines of the overlapped seam are jointed continuously or intermittently by bonding or welding, as required. However, jointing of the rhombus is not mandatory.

When a set of two pyramidal surface slabs are used for jointing, a grid pattern jointed to the pyramidal surface slabs of the upper and lower chords can be obtained. This linear grid plays an important role for the space truss structure surface slab assembly.

As shown in FIG. 13, the finish layers 131 and 132 (surface slab or reinforcing flat plate) can each be laminated on the pyramidal surface slabs 1 and 2 of the upper and lower chords. To put it another way, the space truss structure surface slab assembly 100 formed as a core member is sandwiched between the finish layers 131 and 132.

Referring to FIGS. 14 and 15, the dynamic properties and features of the space truss structure surface slab assembly represented by the aforementioned embodiments will be described.

FIG. 14 is a cross sectional view of pyramidal surface slabs already formed, and FIG. 15 is a cross sectional view of a space truss structure surface slab assembly 100 formed by jointing the pyramidal surface slab of the upper plate with the pyramidal surface slab of the lower plate.

The pyramidal surface slabs 1 and 2 provided as single units already formed in FIG. 14 constitute the pyramidal surface slabs used for assembling the space truss structure surface slab assembly 100. The pyramidal surface slabs are always used as a space truss structure surface slab assembly by integrally jointing the pyramidal surface slab 2 of the upper plate with the pyramidal surface slab 1 of the lower plate.

As shown in FIG. 15, the contact points a₃ and b₃ that occur at the point b₃ on the line of the chord member b₁ of the pyramidal surface slab 2 of the upper plate, and the point a₃ on the line of the chord member a₁ of the pyramidal surface slab 1 of the lower plate are bonded or welded to form one integral body.

The surface b₁ of the pyramidal surface slab of the upper plate of the space truss structure surface slab assembly 100 in FIG. 15, constructed in the aforementioned manner, and the surfaces a₁ of the lower plate are made hollow in a concave pyramidal form. The space truss structure surface slab assembly 100 constructed by jointing provides a structural slab characterized by extremely high strength, and it can be used, without another reinforcing flat plate being provided particularly on the outer surfaces of the pyramidal surface slab of the upper plate and the pyramidal surface slab of the lower plate.

A structural slab of still higher strength can be obtained by providing another flat plate for reinforcement on the outer surfaces of the pyramidal surface slab 2 of the upper plate and the pyramidal surface slab 1 of the lower plate (FIGS. 4 and 9). These structural slabs formed in multiple layers will provide a multi-layered space truss structure surface slab assembly of still higher strength as a panel core material.

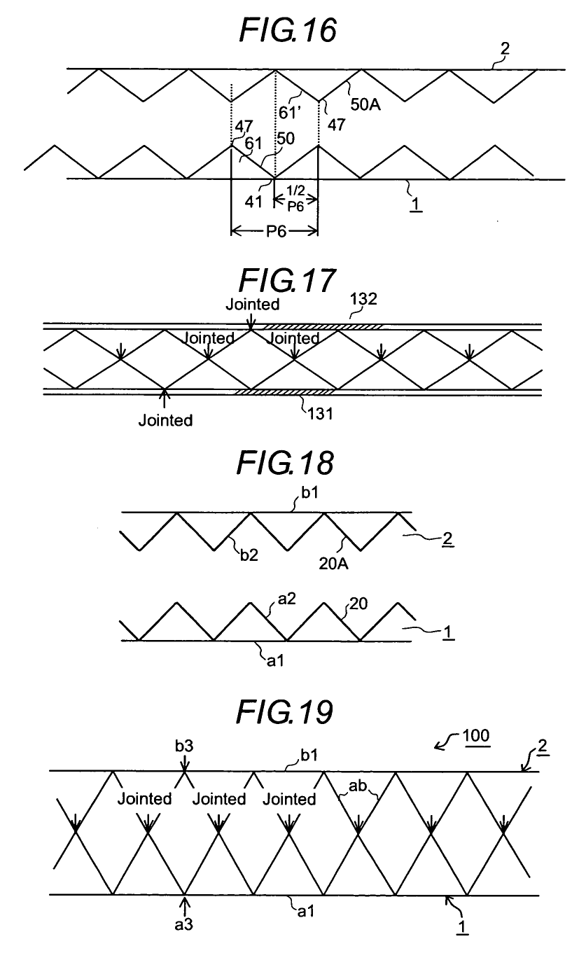

FIGS. 16 through 19 provide alternatives to the arrangements shown in FIGS. 12 through 15, respectively. In the example shown in FIGS. 12 through 15, the apex rhombus of one pyramidal surface slab is jointed with the nadir rhombus of the other pyramidal surface slab placed opposite thereto, by bonding or welding, whereby a space truss structure surface slab assembly in the form of an integral body is constructed. In the variations shown in FIGS. 16 through 19, the apex rhombus of one pyramidal surface slab is jointed with an apex rhombus of the other pyramidal surface slab placed opposite thereto, by bonding or welding, whereby a space truss structure surface slab assembly in the form of an integral body is constructed.

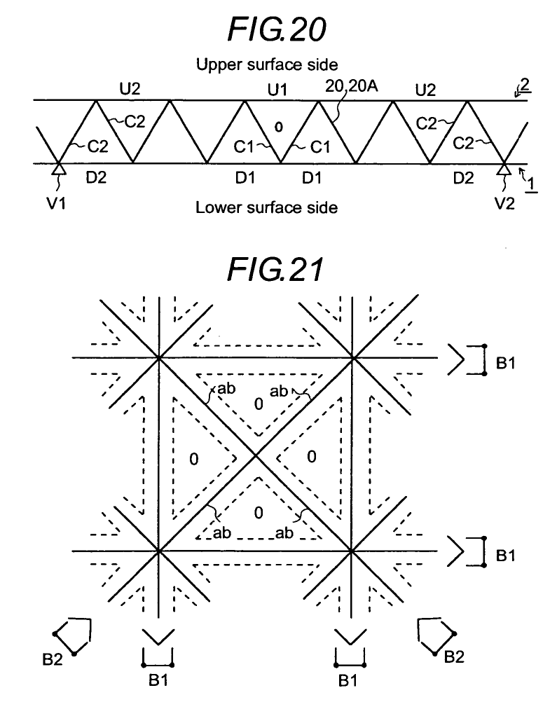

The dynamic properties of the space truss structure surface slab assembly will be described with reference to FIG. 20. The points V₁ and V₂ shown in FIG. 20 represent support points of the space truss structure surface slab (hereinafter referred to as “structure surface slab”). The structure surface slab is a uniform slab devoid of direction in strength as a slab.

As shown in FIG. 20, when a load is applied on the upper surface of the structure surface slab, the bending moment on the point 0 at the center of the slab section is maximized. This bending moment works as a compression on the upper surface side of the structure surface slab, and as a tension on the lower surface side, and both bending moments of the slab section are converted to an axial force by the top chord b₁ and lower chord a₁.

For the axial stress of each, compressive stress is reduced from U₁ to U₂ on the upper surface side in the direction of the support points V₁ and V₂. Likewise, on the lower surface side, tension is reduced in the direction of support points V₁ and V₂ from D₁ to D₂.

The stress of the diagonal member of the rhombus ab line in FIG. 15 becomes a stress formed as a pair of compression and tension stresses. Since it transmits the stress of the applied slab load to the support points V_{1 and V}₂, the stress of the diagonal member conversely is increased in the direction of the support points V_{1 and V}₂ from C₁ to C₂. The stress mechanism described so far is also applicable to the case of a general space truss slab, such as a steel pipe. One of the big differences from this structure surface slab can be described as follows: In the case of a space truss slab in the form of a steel pipe, the pipe is subjected to compressive buckling, with the result that the strength is affected by the compressive buckling and the dynamic efficiency is reduced. By contrast, in the case of the structure surface slab, all members are formed as truss surface members having a two-dimensional expansion, without the truss member being made of wire. As this structure surface slab is shown in FIG. 15, both the chord members a₁ and b₁ and the diagonal member ab work as a V-shaped planar member, as shown in FIG. 21; therefore, there is very little reduction in the strength due to buckling as in the case of a pipe member, with the result that this arrangement ensures a substantial improvement in the strength and rigidity of the slab.

Thus, a saving of material resources and a significant cost reduction will be achieved by the substantial improvement in dynamic efficiency.

FIG. 21 shows the stress mechanism wherein both the chord members a₁ and b₁ and the diagonal member ab are planar and work as a member having dynamically equivalent effective widths B₁ and B₂.

If both members work as V-shaped or inverted V-shaped members having effective widths, the barycentric portion “0” of each triangular surface in the figure is continuous to the V-shaped and inverted V-shaped portions of these members in planar terms. This arrangement provides a stress mechanism that is very effective in protecting each member against buckling.

The following Tables 1-8 indicate the specifications for producing the aforementioned pyramidal surface slab, using the materials of <1> galvanized plate, <2> copper plate, <3> calcium silicate board, <4> Gypsum board, <5> synthetic resin, <6> plywood, <7> paper and pulp and <8> glass. The specification items in these Tables are described below. The Tables are followed by descriptions of specific applications.
Galvanized sheet: Galvanized plate formed by zinc plating
Galvanized steel plate: Galvanized plate of galvalium
Plate thickness: Plate thickness of material in use (mm)
Slab thickness: Space truss structure surface slab production (mm)
Molding method: Truss surface slab molding method
Specific weight: Ratio of the total dead weight of finished truss surface slab relative to slab thickness
Formwork: Formwork material for concrete
Scaffolding board: Temporary work sheet materials for the construction site
Roof slab: Slab material to be installed between roof beams
Floor slab: Floor slab material installed between building floor beams
Pixel pitch: Size of the molded truss structure surface slab elements (mm)
SS400 steel plate: Name of Japanese standards authorized for the building structure
Single extrusion: Press molding method
Floor and wall slab: Slab material for building floor and wall
Slab size: Size of the space truss structure surface slab assembly product
Calcium silicate board: Building board materials by use of calcium silicate
ALC plate: Building slab materials of aerated concrete
Gypsum board: Building board material wherein both surfaces of the gypsum is wrapped in paper as a core material
Furnace molding: Sheet glass

The cement/pulp recycled paper refers to the semi-liquid raw material obtained by a process wherein the main material made of mere final recycled paper is subjected to pulp liquefaction and is stirred after being mixed with cement and reinforcing fiber. This is molded in the form of a plate to obtain a core plate for a Rnan truss surface slab by use of completely pollution-free reinforced non-combustible paper of excellent properties.

The resin/pulp/recycled paper refers to the war material mixed with resin instead of cement.

TABLE 1
(1) Galvanized plate

| | | | | | | | | | | Core thickness | |
|---|---|---|---|---|---|---|---|---|---|---|---|
| | | | | | | | | | | t/3 | |
| | | | | | | | | | | Filled | |
| Truss surface slab core | | | Surface plate | | By laser spot welding | | | Dead | Pixel | with | Specific |
| | Plate | Molding | | Plate | Slab | Applica- | Slab size | weight | pitch | rock | gravity |
| Slab type | thickness | method | Slab type | thickness | thickness | tion | m | kg/m³ | mm | wool | γ |
| Galvanized | 0.4 | Continuous | Galvanized | 0.3 | 15 | Formwork | 1 × 1, 1 × 2, | 11.0 | 19.1 | x | 0.73 |
| sheet | | | steel plate | | 20 | | 1 × 3, 1 × 4 | | 26.1 | | 0.55 |
| | | | | | 30 | | | | 40.3 | | 0.37 |
| Galvanized | 0.5 | Continuous | Galvanized | 0.35 | 20 | Scaffold- | 0.4 × 2, | 13.4 | 25.7 | x | 0.67 |
| sheet | | | steel plate | | 30 | ing board | 0.4 × 3, | | 39.8 | | 0.45 |
| | | | | | | | 0.4 × 4 | | | | |
| Galvanized | 0.6 | Continuous | Galvanized | 0.5 | 30 | Roof slab | 1 × 3, 1 × 4, | 17.3 | 39.1 | ∘ | 0.58 |
| sheet | | | steel plate | | 50 | | 1 × 6, 1 × 8 | | 67.3 | | 0.35 |
| Galvanized | 0.8 | Single | Galvanized | 0.6 | 80 | Floor slab | 1 × 4, 1 × 6, | 22.0 | 108.8 | ∘ | 0.28 |
| sheet | 1.2 | extrusion | steel plate | 0.8 | 100 | | 1 × 8, 1 × 10 | 31.4 | 135.2 | | 0.31 |
| | 1.2 | | | 0.8 | 120 | | | 31.4 | 163.5 | | 0.26 |

Application:
Best suited for the substrate body slab of a solar battery. Aluminum, titanium and stainless steel can also be used as the surface plate. Usable as roof and body slabs for a container car and rolling stock. Provides the roof and floor slabs of extra-light weight and long size comparable to the ALC slab. Best suited for condominium handrail wall. All slabs required to provide incombustibility can be used for this product.

TABLE 2
(2) Copper plate

| | | | | | | | | | | Core thickness | |
|---|---|---|---|---|---|---|---|---|---|---|---|
| | | | | | | | | | | t/3 | |
| | | | | | | | | | | Filled | |
| Truss surface slab core | | | Surface plate | | By laser welding | | | Dead | Pixel | with | Specific |
| | Plate | Molding | | Plate | Slab | Applica- | Slab size | weight | pitch | rock | gravity |
| Slab type | thickness | method | Slab type | thickness | thickness | tion | m | kg/m³ | mm | wool | γ |
| SS400 | 1.6 | Single | SS400 steel | 1.2 | 100 | Floor and | 1 × 3, 1 × 4, | 44.0 | 132.8 | ◯ | 0.44 |
| steel | | extrusion | plate | | | wall slabs | 1 × 6, 1 × 8 | | | | |
| plate | | | | | | | | | | | |
| SS400 | 2.3 | Single | SS400 steel | 1.6 | 150 | Floor and | 1 × 4, 1 × 6, | 61.7 | 200.1 | ◯ | 0.41 |
| steel | | extrusion | plate | | | wall slabs | 1 × 8, 1 × 10 | | | | |
| plate | | | | | | | | | | | |
| GSS400 | 3.2 | Single | GSS400 | 2.3 | 200 | Floor and | 1 × 4, 1 × 6, | 86.4 | 265.9 | ◯ | 0.43 |
| steel | | extrusions | steel plate | | | wall slabs | 1 × 8, 1 × 10 | | | | |
| plate | | | | | | | | | | | |
| SS400 | 5.0 | Single | SS400 steel | 3.2 | 250 | Floor and | 1 × 4, 1 × 6, | 128.8 | 326.2 | ◯ | 0.52 |
| steel | | extrusion | plate | | | wall | 1 × 8, 1 × 10 | | | | |
| plate | | | | | | slabsb | | | | | |
| GSS400 | 8.0 | Single | GSS400 | 4.5 | 300 | Floor and | 1 × 6, 1 × 8, | 196.4 | 385.4 | ◯ | 0.65 |
| steel | | extrusion | steel plate | | | wall slabs | 1 × 10, 1 × 12 | | | | |
| plate | | | | | | | | | | | |
| SS400 | 9.0 | Single | SS400 steel | 6.0 | 500 | Floor and | 1 × 6, 1 × 8, | 235.6 | 660.7 | ◯ | 0.47 |
| steel | | extrusion | plate | | | wall slabs | 1 × 10, 1 × 12 | | | | |
| plate | | | | | | | | | | | |

Application:
Used in car body slab, bridge floor slab, slabs of ship side wall, desk and bulkhead, massive oil tanker wall slab, etc.
Provides building materials as structures of new type floor and wall slabs characterized by extra-light weight, high strength and long size

TABLE 3
(3) Calcium silicate board

| | | | | | | | | | | Core thickness | |
|---|---|---|---|---|---|---|---|---|---|---|---|
| | | | | | Bonded by cement or its related | | | | | t/3 | |
| Truss surface slab core | | | Surface plate | | material | | | Dead | Pixel | Filled | Specific |
| | Plate | Molding | | Plate | Slab | Applica- | Slab size | weight | pitch | with rock | gravity |
| Slab type | thickness | method | Slab type | thickness | thickness | tion | m | kg/m³ | mm | wool | γ |
| Cement/ | 6 | Contin- | Calcium | 6 | 50 | Wall slab | 1 × 3, 1 × 4, | 20.3 | 19.8 | ◯ | 0.41 |
| pulp | | uous | silicate | | 60 | | 1 × 6, 1 × 8 | | 33.9 | | 0.34 |
| recycled | | | board | | | | | | | | |
| paper | | | | | | | | | | | |
| Cement/ | 10 | Contin- | Calcium | 10 | 80 | Floor and | 1 × 4, 1 × 6, | 33.8 | 28.3 | ◯ | 0.42 |
| pulp | | uous | silicate | | 100 | wall slabs | 1 × 8, 1 × 10 | | 56.6 | | 0.34 |
| recycled | | | board | | 120 | | | | 84.9 | | 0.28 |
| paper | | | | | | | | | | | |
| Cement/ | 12 | Contin- | Calcium | 12 | 150 | Floor and | 1 × 4, 1 × 6, | 40.5 | 110.3 | ◯ | 0.27 |
| pulp | | uous | silicate | | 200 | wall slabs | 1 × 8, 1 × 10 | | 181.0 | | 0.20 |
| recycled | | | board | | | | | | | | |
| paper | | | | | | | | | | | |

Application:
Various new types of building materials characterized by extra-light weight and long size comparable to the ALC slab.

TABLE 4
(4) Gypsum board

| | | | | | | | | | | Core thickness | |
|---|---|---|---|---|---|---|---|---|---|---|---|
| | | | | | Bonded by cement or its | | | | | 100% | |
| Truss surface slab core | | | Surface plate | | related material | | | Dead | Pixel | Filled | Specific |
| | Plate | Molding | | Plate | Slab | Applica- | Slab size | weight | pitch | with rock | gravity |
| Slab type | thickness | method | Slab type | thickness | thickness | tion | m | kg/m³ | mm | wool | γ |
| Cement/ | 10 | Contin- | Fiber- | 15 | 100 | Floor and | 1 × 4, 1 × 6, | 43.3 | 42.4 | ◯ | 0.43 |
| pulp | | uous | filled | | 120 | wall slabs | 1 × 8, 1 × 10 | | 70.7 | | 0.36 |
| recycled | | | gypsum | | | | | | | | |
| paper | | | board | | | | | | | | |
| Cement/ | 15 | Contin- | Fiber- | 21 | 150 | Floor and | 1 × 4, 1 × 6, | 62.7 | 67.9 | ◯ | 0.42 |
| pulp | | uous | filled | | 200 | wall slabs | 1 × 8, 1 × 10 | | 138.6 | | 0.31 |
| recycled | | | gypsum | | | | | | | | |
| paper | | | board | | | | | | | | |

Application:
Various new types of building materials characterized by extra-light weight and long size comparable to the ALC slab.

TABLE 5
(5) Polyester based plate

| | | | | | | | | | | Core thickness | |
|---|---|---|---|---|---|---|---|---|---|---|---|
| | | | | | Bonded by resin or its related | | | | | t/3 | |
| Truss surface slab core | | | Surface plate | | material | | | Dead | Pixel | | Specific |
| | Plate | Molding | | Plate | Slab | Applica- | Slab size | weight | pitch | Color | gravity |
| Slab type | thickness | method | Slab type | thickness | thickness | tion | m | kg/m³ | mm | type | γ |
| Polyester | 3 | Contin- | Polyester | 3 | 30 | Roof and | 1 × 3, 1 × 4, | 8.4 | 17.0 | Clear | 0.28 |
| based | | uous | based | | 50 | wall slabs | 1 × 6, 1 × 8 | | 45.3 | | 0.17 |
| plate | | | plate | | 60 | | | | 59.4 | | 0.14 |
| Polyester | 9 | Single | Polyester | 6 | 80 | Roof and | 1 × 4, 1 × 6, | 21.0 | 45.3 | Clear | 0.26 |
| based | | extrusion | based | | 100 | wall slabs | 1 × 8, 1 × 10 | | 73.5 | | 0.21 |
| plate | | | plate | | 120 | | | | 101.8 | | 0.18 |

Application:
Provides a synthetic resin board as a full-scale building material characterized by extra-light weight and long size. Also provides roof and wall slabs without metallic frame. Also provides roof and wall slabs with curved corner by integral molding. Also provides a full-scale skylight when used with Wired sheet glass.

TABLE 6
(6) Plywood

| | | | | | | | | | | Core thickness | |
|---|---|---|---|---|---|---|---|---|---|---|---|
| | | | | | | | | | | t/3 | |
| Truss surface slab core | | | Surface plate | | Bonded by woody material | | | Dead | Pixel | | Specific |
| | Plate | Molding | | Plate | Slab | Applica- | Slab size | weight | pitch | Color | gravity |
| Slab type | thickness | method | Slab type | thickness | thickness | tion | m | kg/m³ | mm | type | γ |
| Cement/pulp | 3 | Contin- | Plywood | 3 | 30 | Furniture | 1 × 2, 1 × 3, | 9.5 | 17.0 | x | 0.32 |
| recycled | | uous | | | 40 | deck and | 1 × 4, 1 × 6 | | 31.1 | | 0.24 |
| paper | | | | | | frame plate | | | | | |
| Cement/pulp | 4 | Contin- | Plywood | 3 | 30 | Formwork and | 1 × 2, 1 × 3, | 11.6 | 11.3 | x | 0.39 |
| recycled | | uous | | | 40 | scaffolding | 1 × 4, 1 × 6 | | 25.5 | | 0.29 |
| paper | | | | | 50 | board | | | 39.6 | | 0.23 |
| Cement/pulp | 10 | Single | Plywood | 6 | 80 | Roof, floor | 1 × 3, 1 × 4, | 27.4 | 39.6 | ∘ | 0.34 |
| recycled | | extrusion | | | 100 | and wall | 1 × 6, 1 × 8 | | 67.9 | | 0.27 |
| paper | | | | | 120 | slabs | | | 96.2 | | 0.23 |
| Cement/pulp | 18 | Single | Plywood | 9 | 150 | Floor and | 1 × 4, 1 × 6, | 47.3 | 84.9 | ∘ | 0.32 |
| recycled | | extrusion | | 12 | 200 | wall slabs | 1 × 8, 1 × 10 | 50.6 | 147.1 | | 0.25 |
| paper | | | | 12 | 250 | | | 50.6 | 217.8 | | 0.20 |
| Cement/pulp | 30 | Single | Plywood | 15 | 300 | Floor slab | 1 × 4, 1 × 6, | 78.9 | 212.1 | ∘ | 0.26 |
| recycled | | extrusion | | 18 | 400 | eliminating | 1 × 8, 1 × 10 | 82.2 | 345.1 | | 0.21 |
| paper | | | | 21 | 500 | the need of | | 85.5 | 478.0 | | 0.17 |
| | | | | | | using a | | | | | |
| | | | | | | beam | | | | | |

Application:
Provides plywood building materials of extra low weight, furniture board and formwork, and the floor and wall slabs of long size at a reduced price.

TABLE 7
(7) Paper/pulp

| Truss surface slab core | | | Surface plate | | Bonded for paper ware | | | Dead | Pixel | Core thickness |
|---|---|---|---|---|---|---|---|---|---|---|
| | Plate | Molding | | Plate | Slab | Applica- | Slab size | weight | pitch | t/√3 |
| Slab type | thickness | method | Slab type | thickness | thickness | tion | m | kg/m³ | mm | Remarks |
| Corrugated | 0.3 | Contin- | Corrugated | 0.3 | 3 | Reinforced | 1 × 1, 1 × 2, | 0.6 | 1.70 | High-strength |
| cardboard | | uous | cardboard | | 5 | corrugated | 1 × 3, 1 × 4 | | 4.53 | corrugated |
| (original) | | | (original) | | 6 | cardboard | | | 5.94 | cardboard |
| Resin- | 0.5 | Contin- | Resin- | 0.5 | 10 | Paper ware | 1 × 1, 1 × 2, | 1.4 | 9.9 | High-strength |
| impregnated | | uous | impreg- | | 15 | board and | 1 × 3, 1 × 4 | | 17.0 | paper board |
| paper | | | nated paper | | 20 | formwork | | | 24.0 | |
| Resin- | 1.5 | Contin- | Resin- | 1.0 | 50 | Building | 1 × 2, 1 × 3, | 3.5 | 59.4 | High-strength |
| impregnated | | uous | impreg- | | 60 | material of | 1 × 4, 1 × 6, | | 73.5 | paper board |
| paper | | | nated paper | | 100 | slab product | 1 × 8 | | 130.1 | |

Application:
Provides a corrugated cardboard characterized by a stunning strength comparable to the plywood.
Provides full-scale paper products as various types of building material slabs.

TABLE 8
(8) Glass

| | | | | | | | | | | Core thickness | |
|---|---|---|---|---|---|---|---|---|---|---|---|
| | | | | | | | | | | t/3 | |
| Truss surface slab core | | | Surface plate | | Bonded by sealant | | | Dead | Pixel | | Specific |
| | Plate | Molding | | Plate | Slab | Applica- | Slab size | weight | pitch | Color | gravity |
| Slab type | thickness | method | Slab type | thickness | thickness | tion | m | kg/m³ | mm | type | γ |
| Sheet | 10 | Furnace | Wired | 6.8 | 100 | Wall and | 1 × 6, 1 × 8, | 85.4 | 65.6 | Trans- | 0.85 |
| glass | | molding | sheet | | | roof slabs | 1 × 10 | | | parent | |
| | | | glass | | | | | | | | |
| Sheet | 15 | Furnace | Wired | 9 | 150 | Wall and | 1 × 8, 1 × 10, | 121.8 | 101.8 | Trans- | 0.81 |
| glass | | molding | sheet | | | roof slabs | 1 × 12 | | | parent | |
| | | | glass | | | | | | | | |
| Sheet | 20 | Furnace | Wired | 12 | 200 | Wall and | 1 × 10, 1 × 12, | 162.4 | 135.8 | Trans- | 0.81 |
| glass | | molding | sheet | | | roof slabs | 1 × 15 | | | parent | |
| | | | glass | | | | | | | | |
| Sheet | 25 | Furnace | Wired | 15 | 250 | Wall and | 1 × 12, 1 × 15, | 203.0 | 169.7 | Trans- | 0.81 |
| glass | | molding | sheet | | | roof slabs | 1 × 20 | | | parent | |
| | | | glass | | | | | | | | |

Application:
Provides wall and roof slabs of massive size from a sheet glass, without using a metallic frame material. Also provides a floor slab for pedestrians.

To improve efficiency in the industry, a great variety of hollow structure slabs have been put into commercial use. To produce a plate-formed hollow structure slab, the aforementioned space truss structure surface slab assembly using a pyramidal surface slab can be said to provide a structural mechanism that ensures the maximum dynamic high efficiency at an unprecedented level. This technique provides all sorts of industries with hollow structure slabs, independently of the type—from small plates to large plates. Since dynamic high efficiency directly leads to economical advantages, all sorts of structure slabs are ensured by unprecedented massive cost cutting and resource saving. Thus, the progress and contribution of the space truss structure surface slab according to the present invention can be said to be stunning beyond comparison.

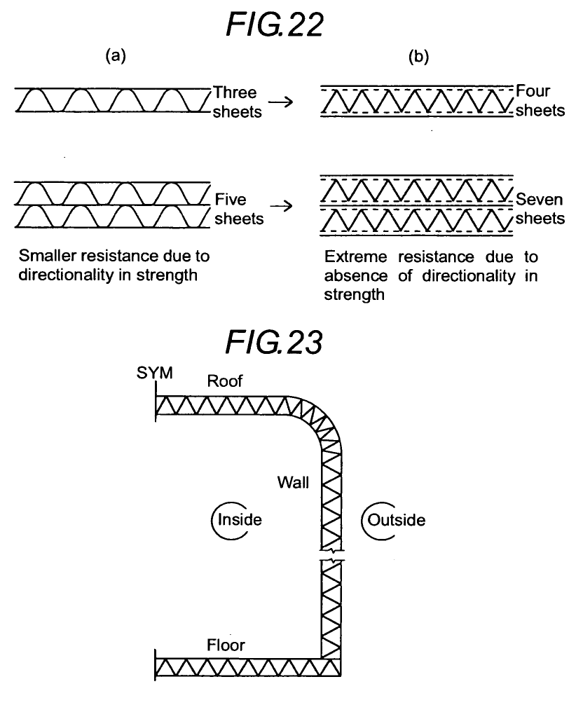

Referring to FIGS. 22(a) to 29(b), examples of the method of use and characteristics for each application of the present invention will be described.

The aforementioned space truss structure surface slabs can be used in a great variety of hollow structure slabs in the industry, independently of their type.

The structure surface slab can be used over a wide range from small to large slabs for the pitch size in the truss pyramid formation.

The specific method of use and characteristics of the structure surface slab of the present invention will be described in the ascending order of pitch size—from small to large pitches of the pyramid surface slab.

Example of Use in Corrugated Cardboard

Corrugated cardboard is made of a paper roll bonded on both sides of corrugated paper so that it is sandwiched between them, as shown in FIG. 22(a). Strength has directionality, and there is a limit to the size of paper ware. When used in a massive box and other large items, it is formed as a multi-layered structure in some cases. It is not very strong—it is not suited to packing heavy equipment in excess of 100 kg. When corrugated cardboard is formed using the aforementioned space truss structure surface slab construction, the pyramidal surface slab of the paper can be continuously molded by a rotary type die. Accordingly, this is processed as a two-piece set in a structure surface slab, and two paper rolls are pressure-bonded to this from both sides. This can be easily molded into a multi-layered form.

As shown in FIG. 22(b), when the corrugated cardboard is formed by a space truss structure surface slab construction, a board without directionality in strength can be easily obtained. It has a stunning strength. A desired massive package unachievable with prior known technique can now be obtained by changing the board thickness variously. The slab has strength comparable to solid concrete panel plywood, and provides a package box capable of packing hundreds of kilograms of heavy equipment.

The aforementioned pyramidal surface slab is formed as a corrugated cardboard, and the aforementioned space truss structure surface slab assembly is constructed wherein the aforementioned apex rhombuses and nadir rhombuses are bonded.

Example of Use in Furniture Body Board and Step

When a furniture body board and step are fabricated with a hollow slab, a wooden grid and honeycomb paper are used as core material on a substrate, and finishing plywood and other materials are bonded thereto from both surfaces, according to prior known techniques. If this is fabricated using the space truss structure surface slab as the core material, an unprecedented high-strength board can be easily obtained. Thus, board of a desired thickness can be produced at a very low cost. For the board for furniture, the core material formed of a small-pitch pyramidal surface slab using paper impregnated with resin is sufficient. Thus, this is used as a core material and both surfaces are finished with plywood and other materials.

Due to a very light weight and tremendous strength, a board having a massive size that has not been achieved so far can be obtained at a low price. Further, the pyramid pitch of the structure surface slab is much smaller than the previously used wooden grid pitch, and the thickness of the finishing panel used on both surfaces can be very small.

The aforementioned pyramidal surface slab provides a space truss structure surface slab assembly constructed by a thin wooden board or plywood.

An Example of Use in a Truck Deck Plate and a Container Car Roof and a Wall Body

The truck deck plate and container car roof and wall body used heretofore have been made of light metal plate that is molded and other materials, with rib material inserted therein. As shown in FIG. 23, on the other hand, a space truss structure surface slab can be used in such a deck board, and to can be used to improve the rigidity of a container car roof and wall by use of an integral molding procedure. Especially, the roof and wall of the container car is formed by changing the pitches of both the inner and outer plates of the pyramidal surface slab, whereby the corners can be molded into an integral unit, without using a rib. This provides a roof and wall and body of extremely high rigidity. If a light metal plate is used for finishing both the inside and outside, a smart body free from any protrusions can be ensured. FIG. 23 is a cross sectional view of the structure surface slab used in the roof, wall and floor.

A space truss structure surface slab assembly is constructed, wherein two types of space truss structure surface slab assemblies, where the pitch of a pyramidal surface arranged in a grid pattern is changed, are used in one structure.

An Example of an Aircraft Body and Floor

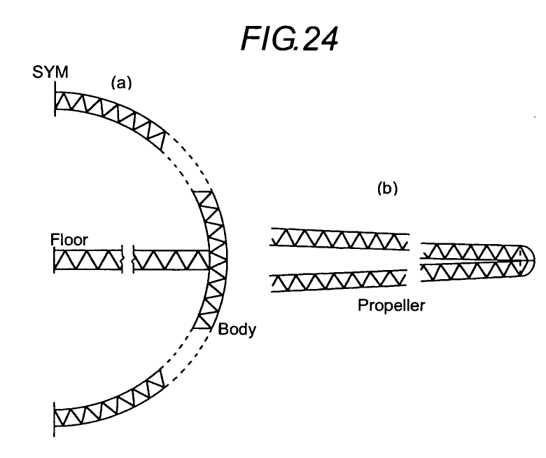

Heretofore, an aircraft body and floor have been finished by assembling the hollow slabs where the rid material and honeycomb paper of the grid are used as core materials, and by laminating a light metal plate thereto both inside and outside. As shown in FIG. 24(a), on the other hand, a space truss structure surface slab can be molded and processed in such a curved form, and this allows such a body to be made into a highly rigid structure by integral molding with the floor slab. FIG. 24(a) is a cross sectional view of the space truss structure surface slab when used in the body and floor, and FIG. 24(b) is a cross sectional view of the space truss structure surface slab when used in a propeller.

A space truss structure surface slab assembly is molded and processed on a curved surface, using the aforementioned two pyramidal surfaces.

Example of Use in the Deck and Bulkhead of a Tanker and Other Type of Ship

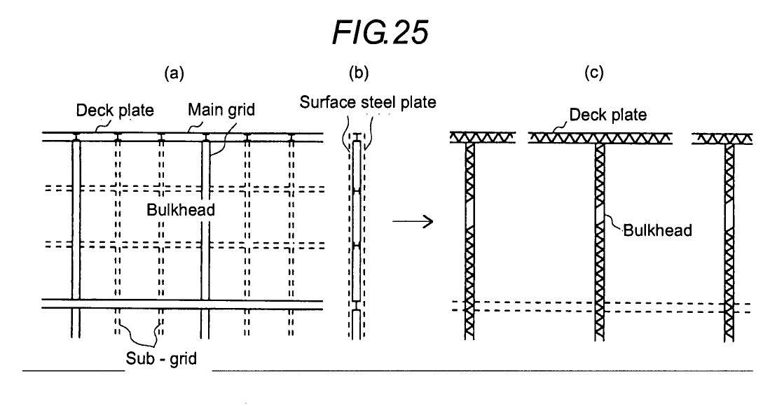

Heretofore, to fabricate the deck and bulkhead of a tanker and other ships, the rib materials have been arranged in a grid pattern using section steel, and the steel plate is welded on both surfaces, as shown in FIGS. 25(a) and 25(b). In this case, if the grid pattern of the rib material has a coarse pitch, the area of the steel plate of one block is increased, thereby increasing the thickness of the steel plate laminated on both surfaces. Conversely, if the grid pattern has a fine pitch, the area of the steel plate of one block is decreased. However, this leads to an increase in the number of rib members to be used and in the amount of the steel material to be used. In designing a structure according to this method, both the grid material and steel plate are determined by the strength to bending stress. This method is characterized by very low dynamic efficiency and poor profitability. The construction work is basically labor-intensive work and provides almost no advantages of volume production.

If the aforementioned space truss structure surface slab assembly is used in a ship's deck and bulkhead, as shown in FIG. 25(c), the advantages of volume production are introduced into the process from steel plate to pyramidal surface using a large-sized press. Since the space truss structure surface slab using steel plate provides for a highly efficient production of slabs of very high strength, excellent effects can be obtained. The pitch of the pyramidal surface slab is much smaller than that of the rib material of a grid pattern, so that the thickness of the plates to be attached to both surfaces can be very small, with the result that a substantial cost cutdown and a saving of resources, as well as a dynamic characteristic of high efficiency, can be achieved.

As the aforementioned pyramidal surface slab, a space truss structure surface slab assembly is produced by pressing the steel plate.

Example of Use in Floor and Wall Slabs of a Building

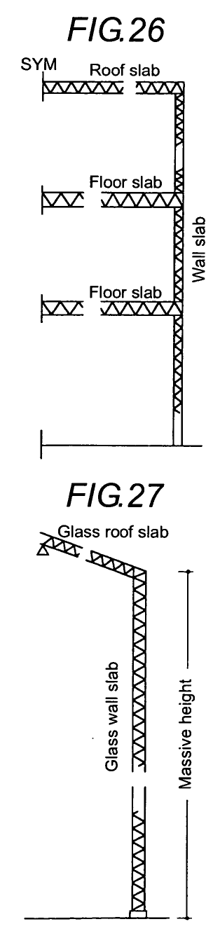

Except for a reinforced concrete structure, all the floors and walls of buildings, such as apartment houses, for example, have use of a pillar and beam. The floors and walls are handled as finishing materials and do not constitute a structure in such buildings. The space truss structure surface slab assembly shown in FIG. 26 can be completely used, without a pillar or beam, as the main structure of the wooden and steel frame structures of a building, other than a reinforced concrete structure. FIG. 26 is a cross sectional view representing the space truss structure surface slab used as a structure. The desired thickness and size of the structure surface slab can be obtained by changing the pitch of the pyramid mold. Further, a slab having a very high degree of strength and resistance can be easily produced. This has the advantage of providing a structure consisting of a structure surface slab alone without the previously required pillar and beam. Another advantage gained therefrom is that the member of the pyramidal surface slab used as the building material for such a slab can be molded at a very low cost.

If waste paper currently assumed as waste that cannot be recycled, it can be recycled can be used to form the pyramidal surface slab of the core material. The final waste paper is re-decomposed and is covered with cement. This is subjected to continuous molding, such as rotary type molding. This arrangement permits easy fabrication of the member of the pyramidal surface slab of the space truss structure surface slab. This is combined, and a sheet building material, such as calcium silicate, is laminated on both surfaces. Then, a structure surface slab serving as a slab building material can be created. The recycled paper covered with cement is non-flammable, and the structure surface slab made thereof represents the introduction of a very economical, highly value-added building material that has never appeared so far. It is anticipated that its use will cause the concept of a building to undergo a radical change.

A sheet building material, such as a calcium silicate board, is used as a flat plate, and a space truss structure surface slab assembly to be laminated on both surfaces is produced.

An Example of Use in a Glass Wall and Roof Slabs of Massive Height

A glass-walled building of endlessly increased size has come to be designed in recent years. However, there is no way of designing a 30-meter high glass walled building, without using any metallic frame members. However, this object can be achieved if the aforementioned space truss structure surface slab assembly is made of glass. FIG. 21 is a cross sectional view of a structure surface slab made of glass.

The structure surface slab made of glass is manufactured as follows: A mold for the pyramidal surface slab having the pitch and height required for molding is placed in a horizontal position and a glass plate is placed thereon. When it has been heated to a required temperature in a high-temperature furnace, the glass plate is turned into a half-molten state (like starch syrup), and comes into close contact with the surface of the mold, whereby the aforementioned pyramidal surface slab is formed. This plate is taken out of the furnace, and a hardened pyramidal surface slab is obtained. Two pyramidal surface slabs are assumed to form one set, and the substrate for the space truss structure surface slab is processed. The glass plate is laminated on both surfaces in a staggered arrangement, thereby obtaining a space truss structure surface slab made of glass.

For a structure surface slab made of glass plate, the roof corner can theoretically be molded at the same time, as shown in FIG. 27, and molding of the corner on a curved surface is also possible. This arrangement is anticipated to provide a heretofore unimaginable massive glass wall having a high degree of strength.

The aforementioned procedure provides a space truss structure surface slab assembly wherein the pyramidal surface slab is fabricated as a glass-made slab.

Example of Use in a Large Circular Tank of a Pressure Vessel

A huge circular tank is typically used to store petroleum. The circular tank is normally made of a steel plate laminated on the top surface of a reinforced concrete floor slab. Most of the walls are constructed similar to cover-less pails formed by welding solid steel plate. Since the design is mostly determined by the bending stress, the economic efficiency is very low.

A massive tank of this type is characterized by a huge bending stress. To withstand this stress, the maximum thickness of the plate to be used ranges from 20 through 50 mm, and its dead weight is very large.

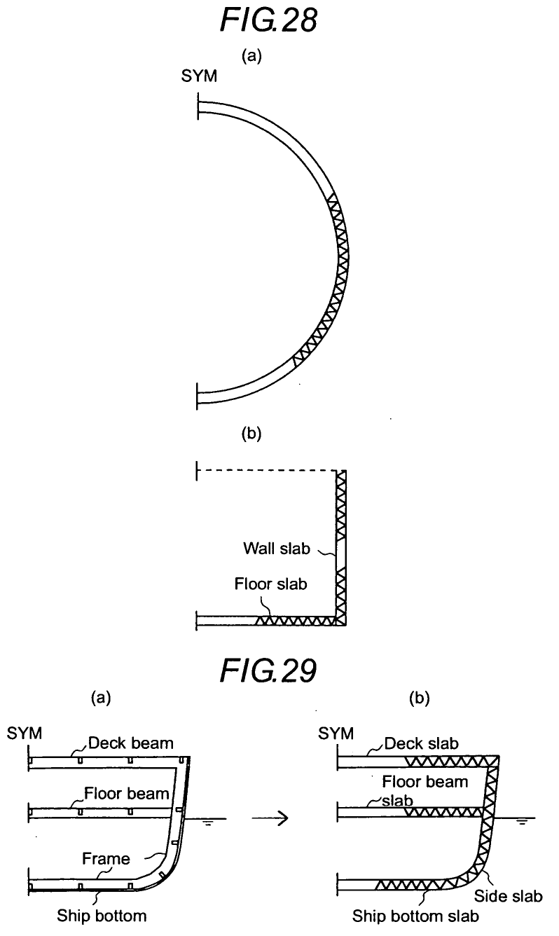

FIGS. 28(a) and 28(b) are plan views of a circular tank using a space truss structure surface slab characterized by high efficiency, extra-light weight and high strength.

Features of a Large-Sized Tank Using a Structure Surface Slab

1) The thickness of the steel plate used is very small due to dynamically high efficiency, with the result that an extra-light weight tank can be obtained.

2) As a result, the amount of the steel used is reduced to less than a half.

3) This arrangement easily provides an extra-large tank that cannot possibly be manufactured using previously known methods.

4) A tank characterized by greater rigidity and holding strength than those provided heretofore can be produced.

5) A substantial cost cutdown is achieved as compared with prior constructions.

6) If the pyramidal surface slab has a greater thickness, the pyramidal surface slabs separately pressed and molded are assembled and can be fabricated by field welding, together with the steel plates laminated on both surfaces.

7) A wall slab of variable cross section can be easily obtained wherein the upper slab of the tank wall is thinner, and the lower slab exposed to a very great stress is thicker, as required.

Example of Use as a Ship Hull Structure

The conventional ship hull structure is basically as shown in FIG. 29(a). That is, the frame material is raised from the ship bottom in a curved shape, and a deck beam is jointed thereto to ensure a rigid hull structure. The direction of the deck beam orthogonal to the frame material is determined in such a way that an orthogonal beam for lateral stiffening is provided, and it is jointed integrally with the frame material to withstand the expected water pressure, if there is a floor beam at the intermediate position, similarly to the case of the deck beam. For the lengthwise direction of the ship, the orthogonal beams arranged on the deck and ship bottom play an important role to withstand the wave pressure applied from the longitudinal direction.

The space truss structure surface slab shown in FIG. 29(b) can be used entirely if the hull can be welded as an integral structure. An FRP material, iron material, aluminum material, etc. are ideal materials for the hull structure.

Features When the Hull Structure is Designed Using a Structure Surface Slab

1) The thickness of the plate of the material used is very small due to a dynamically high efficiency, with the result that an extra-light weight hull can be obtained.

2) As a result, the amount of the FRP material and steel used is substantially reduced.

3) The structure surface slab is hollow without exception. Thus, if the slab thickness is correctly determined in the design, the specific weight of the slab is reduced, with the result that the ship does not sink even if the interior of the ship is submerged.

4) A steel-made ship does not sink even if submerged.

5) The hull slab, side plate slab, floor beam slab and deck slab can be formed into integral structures characterized by extra-light weight and high strength, without requiring use of a frame material or rib material, such as an orthogonal beam.

6) Whereas almost all of the previously used shipbuilding work is labor-intensive work, the major slabs in the structure surface slab production process are based on a volume production method of press molding, with the result that the productivity is much improved.

7) If the pyramidal surface slab has a greater thickness, the pyramidal surface slabs separately pressed and molded are assembled and can be fabricated by field welding, together with the steel plates laminated on both surfaces.

8) The slab thickness for various sections of the hull can be changed as required, so that the slab thickness of the variable cross section can be designed as desired.

Further, if required, two or three space truss structure surface slabs can be designed. The space truss structure surface slab assembly of the present invention is applicable to all of the following cases:

1) A corrugated cardboard box having a massive strength for packing heavy equipment in excess of 100 kg.

A 2-meter-by-4-meter large-sized plywood sheet characterized by massive holding capacity, extra-light weight and low cost.

A 2-meter-by-5-meter large-sized table characterized by two legs on both ends, extra-light weight and low cost.

A non-concrete floor building material of extra-light weight that can be supported at intervals of 3 through 5 meters.

A 2-meter-by-4-meter large-sized plywood mold and steel plate formwork characterized by extra-light weight and low cost.

2) A 30-meter high large-sized glass wall without metallic reinforcement.

A 2-meter-by-6-meter roof slab and wall slabs formed by an acryl resin slab.

3) A truck and rolling stock having an integrated floor, wall and roof structure characterized by extra-light weight and high rigidity.

4) A steel ship and FRP ship structure, without a frame, that do not sink even when submerged.

A structural building, such as an apartment house having an integrated floor, wall and roof structure characterized by extra-light weight and seismic resistance.

5) Very economical construction of a gigantic tank having a diameter of 100 meters or more and a height of 50 meters or more.

1. A space truss structure surface slab assembly characterized in that:
an apex rhombus is delimited over the center point of a polygon delimited by plotting a plurality of nadir rhombuses on one and the same plane;
each of said nadir rhombuses and the apex rhombus are jointed to form a group of pyramidal surfaces equipped with a plurality of planar slopes and having substantially the same height in a triangular pyramid;
two pyramidal surface slabs, each of which is composed of said pyramidal surfaces around one pyramidal surface, each sharing one nadir rhombus, adjacent to each other, and arranged in a grid pattern at an equal pitch in two or three directions, are assembled;
the pyramidal surfaces arranged in a grid pattern are each displaced by one-half pitch in a specific direction in such a way that the apex rhombus of one of the pyramidal surfaces is opposed to the nadir rhombus of the other pyramidal surface, and the apex rhombus of the other pyramidal surface is opposed to the nadir rhombus of the counterpart pyramidal surface, whereby said two pyramidal surfaces are assembled; and furthermore,
the apex rhombus of one pyramidal surface slab and a nadir rhombus of the other pyramidal surface slab opposed thereto are integrally jointed by bonding or welding, whereby a space truss structure assembly is formed.

2. The space truss structure surface slab assembly according to claim 1, wherein a planar surface plate is laminated outside each of the two pyramidal surface slabs so that the space truss structure assembly is sandwiched between them.

3. The space truss structure surface slab assembly according to claim 1, wherein a pyramidal surface slab is made of sheet metal.

4. The space truss structure surface slab assembly according to claim 1, wherein a pyramidal surface slab is made of a corrugated cardboard, and said apex rhombus and nadir rhombus are bonded with each other.

5. The space truss structure surface slab assembly according to claim 1, wherein a pyramidal surface slab is made of a thin wooden plate or plywood.

6. The space truss structure surface slab assembly according to claim 3, wherein two types of space truss structure surface slab assemblies, with a pyramidal surface slab arranged in a grid pattern having different pitches, are used as one structure.

7. The space truss structure surface slab assembly according to claim 3, wherein said two pyramidal surface slabs are entirely molded in a curved surface.

8. The space truss structure surface slab assembly according to claim 3, wherein a pyramidal surface slab is produced by pressing a steel slab.

9. The space truss structure surface slab assembly according to claim 2, wherein a thin building material including calcium silicate board is used as a flat plate.

10. The space truss structure surface slab assembly according to claim 2, wherein a pyramidal surface slab is constructed as a glass slab.

11. A space truss structure surface slab assembly characterized in that
an apex rhombus is delimited over the center point of a triangle or a square which is delimited by plotting three, four or six nadir rhombuses on one and the same plane;
each of said nadir rhombuses and said apex rhombus are jointed to form a group of pyramidal surfaces equipped with three, four or six planar slopes and having substantially the same height in a pyramidal form;
two pyramidal surface slabs, each of which is composed of said pyramidal surfaces around one pyramidal surface, each sharing one nadir rhombus, adjacent to each other, and arranged in a grid pattern at an equal pitch in two or three directions, are assembled;
the pyramidal surfaces arranged in a grid pattern are each displaced by one-half pitch in a specific direction in such a way that the apex rhombus of one of the pyramidal surfaces is opposed to the nadir rhombus of the other pyramidal surface, and the apex rhombus of the other pyramidal surface is opposed to the nadir rhombus of the counterpart pyramidal surface, whereby said two pyramidal surfaces are assembled; and
the apex rhombus of one pyramidal surface slab and a nadir rhombus of the other pyramidal surface slab opposed thereto are integrally jointed by bonding or welding, whereby a space truss structure assembly is formed.

12. The space truss structure surface slab assembly according to claim 11, wherein a planar surface plate is laminated outside each of the two pyramidal surface slabs so that the space truss structure assembly is sandwiched between them.

13. The space truss structure surface slab assembly according to claim 11, wherein a pyramidal surface slab is made of sheet metal.

14. The space truss structure surface slab assembly according to claim 11, wherein a pyramidal surface slab is made as a corrugated cardboard, and said apex rhombus is bonded with said nadir rhombus.

15. The space truss structure surface slab assembly according to claim 11, wherein a pyramidal surface slab is made of a thin wooden plate or plywood.

16. The space truss structure surface slab assembly according to claim 13, wherein two types of space truss structure surface slab assemblies, with a pyramidal surface slab arranged in a grid pattern having different pitches, are used as one structure.

17. A space truss structure surface slab assembly characterized in that:
an apex rhombus is delimited over the center point of a polygon delimited by plotting a plurality of nadir rhombuses on one and the same plane;
each of said nadir rhombuses and the apex rhombus are jointed to form a group of pyramidal surfaces equipped with a plurality of planar slopes and having substantially the same height in a triangular pyramid;
two pyramidal surface slabs, each of which is composed of said pyramidal surfaces around one pyramidal surface, each sharing one nadir rhombus, adjacent to each other, and arranged in a grid pattern at an equal pitch in two or three directions, are assembled;
the pyramidal surfaces arranged in a grid pattern are each displaced by one-half pitch in a specific direction, in such a way that the apex rhombus of one of the pyramidal surfaces is opposed to the nadir rhombus of the other pyramidal surface, and the apex rhombus of the other pyramidal surface is opposed to the nadir rhombus of the counterpart pyramidal surface, whereby said two pyramidal surfaces are assembled; and furthermore,
the apex rhombus of one pyramidal surface slab and the nadir rhombus of the other pyramidal surface slab opposed thereto are integrally jointed by bonding or welding, whereby a space truss structure surface slab assembly is formed.

18. A space truss structure surface slab assembly characterized in that:
an apex rhombus is delimited over the center point of a triangle or a square which is delimited by plotting three, four or six nadir rhombuses on one and the same plane;
each of said nadir rhombuses and said apex rhombus are jointed to form a group of pyramidal surfaces equipped with three, four or six planar slopes and having substantially the same height in a pyramidal form;
two pyramidal surface slabs, each of which is composed of said pyramidal surfaces around one pyramidal surface, each sharing one nadir rhombus, adjacent to each other, and arranged in a grid pattern at an equal pitch in two or three directions, are assembled;
the pyramidal surfaces arranged in a grid pattern are each displaced by one-half pitch in a specific direction in such a way that the apex rhombus of one of the pyramidal surfaces is opposed to the nadir rhombus of the other pyramidal surface, and the apex rhombus of the other pyramidal surface is opposed to the nadir rhombus of the counterpart pyramidal surface, whereby said two pyramidal surfaces are assembled; and
the apex rhombus of one pyramidal surface slab and an apex rhombus of the other pyramidal surface slab opposed thereto are integrally jointed by bonding or welding, whereby a space truss structure assembly is formed.
